(19) United States
(12) Patent Application Publication
(10) Pub. No.: US 2007/0184553 A1
(43) Pub. Date: Aug. 9, 2007

(54) Method of automatically regulating and measuring pressure during sampling and analysis of headspace gas

(76) Inventors: Thomas M. Hartlein, Lebanon, OH (US); Edward K. Price, Liberty Township, OH (US); Eric T. Heggs, Camden, OH (US); Adam G. McGee, Loveland, OH (US)

Correspondence Address: KIRKPATRICK & LOCKHART PRESTON GATES ELLIS LLP, 535 SMITHFIELD STREET, PITTSBURGH, PA, 15222, US

(21) Appl. No.: 11/348,092

(22) Filed: Feb. 6, 2006

(51) Int. Cl. G01N 35/02

(52) U.S. Cl. 436/50

(57) ABSTRACT

A method for automatically regulating and measuring pressure as volatile substances in headspace gas are sampled and then quantitatively or qualitatively analyzed is disclosed. According to various embodiments, the method comprises vials that are automatically sampled by a headspace sampling instrument; the static pressure of the vials is automatically measured and recorded; the vials are automatically pressurized to a predetermined pressure that is greater than the static pressure; and the headspace gas is automatically allowed to flow into a sample loop of the headspace sampling instrument for subsequent qualitative or quantitative analysis. Multiple vials with varying static pressures may also be automatically measured, recorded and individually pressurized on a vial-by-vial basis as the headspace gas from each is automatically sampled and analyzed. Additionally, the pressure of the sample loop within the headspace sampling instrument may also be automatically manipulated on a vial-by-vial basis affording the operator vast flexibility in maximizing the overall sensitivity and reliability of the analyses.

### FIELD OF INVENTION

The present disclosure relates to a method for automatically regulating and measuring pressure as volatile substances in headspace gas are sampled and then quantitatively or qualitatively analyzed.

### BACKGROUND OF INVENTION

Headspace sampling techniques are used to capture and analyze volatile components in largely nonvolatile substances. Both qualitative and quantitative analysis of volatile components from liquid or solid substances can occur with headspace sampling. Liquid or solid substances to be analyzed are placed in a sealed vial. The area above and around the nonvolatile substance within the vial is known as headspace. The vapor within the vial contains volatiles emitted from the liquid or solid substance and equilibrium is reached between the volatiles within the headspace gas and those remaining in the liquid or solid substance. The vapor within the headspace can then be sampled and introduced into an analytical instrument, such as, for example, a gas chromatograph, to determine the identity and concentration of the volatile component(s) within the vapor. Applications commonly utilizing headspace analysis techniques include analyzing blood alcohol concentrations, identifying trace organic compounds in water samples, testing for the presence of solvents in pharmaceutical compounds, and the like.

Sampling of headspace gas may be conducted using either a static or a dynamic headspace sampling technique. Dynamic headspace sampling techniques involve a continual sweep of the headspace with an inert gas in order to concentrate the volatile components on an adsorbent trap. Once the collection process is completed, the trap is heated to desorb the volatile components and then the collected volatile components proceed to an analytical instrument for identification and/or quantification.

Static headspace analysis, on the other hand, first allows equilibrium to be reached within the vial between the volatile and nonvolatile substances. Once at equilibrium, static pressure within the vial is measured and recorded. A single sample of the volatile components within the headspace is then removed from the vial all at once, instead of continually over a time period as with the dynamic headspace technique. The single headspace sample is passed into a sample loop before flowing into an analytical instrument for identification and/or quantification.

The amount of a volatile substance in the headspace gas is governed by the Universal Gas Law, PV=nRT, where P is pressure, V is volume of the headspace, n is the number of moles of the substance, R is a constant and T is temperature of the substance. “n,” as the number of moles of substance within the headspace gas, directly correlates to the mass of the substance, which affects the overall reliability and sensitivity of the analysis. Solving the Universal Gas Law for “n” demonstrates that substance pressure and headspace volume have a direct effect on the amount of the volatile substance in the headspace gas. Since volume is a fixed variable based on vial size, varying the pressure within the headspace has the greatest effect on the amounts of volatile substances within the headspace gas that is sampled and analyzed.

A benefit of headspace sampling is that it occurs in a closed system, thus theoretically making it impossible for mass to be lost or for contaminants to enter the sampling instrument and compromise the results. A liquid or solid sample to be analyzed for volatile components will have a certain amount of volatiles incorporated into the sample. Once in a sealed vial, an amount of volatiles will leave the liquid or solid phase over time and enter the headspace gas. The amount of volatiles entering the gas phase will reach equilibrium based on the temperature and the amount of time the vial is allowed to equilibrate. This can be represented mathematically with the following formula:
M_{O}=M_{G}+M_{M}
whereby M_{O} is the original mass of a substance placed in the vial; M_{G} is the mass of the substance in the gas phase within the headspace after equilibrium; and M_{M} is the mass of the substance remaining in the liquid or solid sample after equilibrium.

Assuming the same sample volume in each vial, samples that have roughly the same make-up (e.g., aqueous samples), will reach the same internal (static) pressure. Thus, prior to sampling and analysis, vials are heated for a predetermined amount of time in order to increase the content of volatiles within the headspace and speed the time needed to achieve equilibrium. The mass that ultimately enters the gas phase is dictated by the partitioning coefficient (K), a physical constant that is directly affected by the temperature of the sample and the pressure in the vial. K can be represented with the following formula:
K=C_{M}/C_{G}
whereby C_{M} is the concentration of the volatile in the sample; and C_{G} is the concentration of the volatile in the gas phase.

Concentration is the result of mass divided by volume. In other words,
C_{M}=M_{M}/V_{M}
and
C_{G}=M_{G}/V_{G}
whereby C_{M} is the concentration of the volatile in the sample; M_{M} is the mass remaining in the sample after equilibrium; V_{M} is the volume of the sample; C_{G} is the concentration of the volatile in the gas phase; M_{G} is the mass in the gas phase after equilibrium; and V_{G} is the volume of the gas phase.

Thus the partition coefficient can be restated as:
K=(M_{M}/V_{M})/(M_{G}/V_{G})

As can be appreciated by those of skill in the art, a lower K value results in a higher concentration of the volatile substance in the gas phase. Some examples of K values for common volatile organic compounds in water at 50° C. are in Table 1.

TABLE 1
Partition Coefficients of Organics From Water at 50° C.

| Compound | K |
|---|---|
| Hexane | 0.015 |
| Benzene | 2.5 |
| Toluene | 2.1 |
| Xylene | 1.3 |
| Methanol | 1670 |
| Ethanol | 1150 |
| n-Propanol | 770 |
| Acetaldehyde | 99 |
| Acetone | 190 |
| Methyl ethyl ketone | 114 |

Another factor affecting the reliability and sensitivity of the analysis is the volume of the substance in the vial. A greater quantity of substance within a vial leaves less headspace and therefore less room for the volatiles to enter the gas phase. This is known as the phase ratio:
V_{G}/V_{M}
where V_{G} is the volume of the gas phase and V_{M} is the volume of the sample.

Thus, the overall sensitivity and reliability of the headspace sampling technique is affected by the partition coefficient and the phase ratio of the sample. In situations where the K value is low, the phase ratio may be altered to reduce the volume of gas in the vial, resulting in a denser mass or higher concentration of the volatile in the gas phase for analysis. These, and other method development techniques are well known in the art.

Another primary factor affecting the overall reliability and sensitivity of the analysis is the pressure of the sampling instrument and equipment tubing that carries the volatile substances from the vial to the analytical instrument. Higher pressures in the tubing result in more mass (i.e., higher concentrations) in the tubing, which improves the overall reliability and sensitivity of the analysis. In the art, the pressure of the equipment tubing within the headspace sampling instrument is also known as “Loop-Fill” pressure. Higher pressures in the equipment tubing also provide the benefit of eliminating the variable of atmospheric pressure.

When analyzing multiple samples with automated systems, such as those described in U.S. Pat. Nos. 6,706,245, 6,146,895, and 6,040,186, assigned to Teledyne Tekmar Company, which are incorporated herein by reference, multiple vials will each contain volatile substances. To achieve efficiency of analysis, users commonly utilize a sampling instrument to automatically handle and consecutively analyze multiple vials, for example, at a time when the operator is not physically present to monitor the analysis (e.g., overnight). Prior art methods and instruments only allowed for the static vial pressure to be observed and recorded manually, and during automated sampling and analysis either an operator would have to be physically present at all times during the sampling and analysis to observe and record the static vial pressures, or the static vial pressures would go unrecorded.

Prior art analytical equipment only provided for one vial pressurization setting to be used for all vials processed during a single automated sampling and analysis event. In such equipment, vials with samples having a lower static vial pressure than other samples would thus receive a greater volume of dilution gas in order to raise the vial pressure to the predetermined pressurization setting. Moreover, the static vial pressure of each vial was not able to be recorded automatically; rather, each vial was brought up to the same overall pressurization setting, regardless of its starting pressure. Hence it was unknown to operators after an automated sampling and analysis event to what extent a particular sample had been diluted since vials having a lower static vial pressure would become diluted to a greater degree due to the addition of a greater volume of gas.

Accordingly, it would be advantageous to allow operators to set multiple vial pressurization settings for multiple samples in an automated sampling instrument in anticipation of an automated sampling event. Likewise, the ability to have the exact vial pressure recorded prior to the sampling and analysis would be beneficial. At the same time, a sampling method that provides the ability to set multiple instrument pressurization settings for multiple samples during an automated sampling event is desired.

### SUMMARY

As a means to address the deficiencies of existing headspace sampling equipment and techniques, one aspect of the present disclosure provides for the automated recordation of static pressure of individual vials before each is sampled during automated analyses of multiple vials. This usually occurs after equilibrium is reached within each vial. Each individual vial can then have added to it either a specific volume of pressurizing gas or enough pressurizing gas to bring the vial to a predetermined pressure based on its individually measured static pressure. In this manner, dilution of samples is kept to a minimum while achieving the desired predetermined vial pressure. This aspect of the present disclosure may be manipulated on a vial-by-vial basis.

Another aspect of the present disclosure allows for the setting and automatic pressurization of the headspace sampling instrument along with the individual vial pressurization settings as described above. This headspace sampling instrument pressurization setting establishes a pressure that is automatically reached within the tubing and sample loop within the sampling instrument as the headspace gas leaves the vial and enters the tubing and sample loop just prior to analysis by the analytical instrument. The ability of a headspace sampling method to automatically adjust the pressure of the equipment tubing and sample loop through a headspace sampling instrument pressurization setting that is specific to a given vial pressurization setting is most advantageous. The size of equipment tubing and sample loop are fixed by the size of the headspace sampling instrument, thus, as explained above, variables such as temperature and pressure within the vial and tubing (e.g., the sample loop) can have significant effects on the ultimate amount of volatiles that are transferred to the analytical instrument for qualitative and/or quantitative identification.

One aspect of the present disclosure allows for a method of automatically regulating and measuring pressure of a vial by a headspace sampling instrument, including, but not limited to, automatically sampling the vial by the headspace sampling instrument, the vial including at least one volatile substance in a headspace gas within the vial; automatically placing the vial on the headspace sampling instrument; automatically measuring and recording a static pressure within the vial via the headspace sampling instrument, automatically pressurizing the vial to a predetermined pressure that is greater than the static pressure via the headspace sampling instrument; and automatically allowing a sample of the headspace gas to flow into a sample loop of the headspace sampling instrument.

Another aspect of the present disclosure allows for a method of automatically regulating and measuring pressure of a plurality of vials by a headspace sampling instrument, including, but not limited to, automatically sampling the vials by the headspace sampling instrument, the vials including at least one volatile substance in a headspace gas within each vial, automatically placing a first vial on the headspace sampling instrument; automatically measuring and recording a static pressure within the first vial via the headspace sampling instrument; automatically pressurizing the first vial to a predetermined pressure that is greater than the static pressure via the headspace sampling instrument; automatically allowing a sample of the headspace gas from the first vial to flow into a sample loop of the headspace sampling instrument; automatically replacing the first vial on the headspace sampling instrument with a second vial; automatically measuring and recording a static pressure within the second vial via the headspace sampling instrument; automatically pressurizing the second vial to a predetermined pressure that is greater than the static pressure of the second vial and is different from the pressure of the first vial via the headspace sampling instrument; and automatically allowing a sample of the headspace gas from the second vial to flow into a sample loop of the headspace sampling instrument.

Still another aspect of the present disclosure allows for a method of automatically regulating and measuring pressure of a headspace sampling instrument and a plurality of vials, including, but not limited to, automatically sampling the vials with the headspace sampling instrument, the vials including at least one volatile substance in a headspace gas within each vial; preparing the plurality of vials; entering predetermined vial pressurization and headspace sampling instrument pressurization settings for each vial into a central processing unit of the headspace sampling instrument; automatically retrieving the first vial and automatically placing the first vial onto the headspace sampling instrument, said first vial having a static pressure; automatically measuring and recording the static pressure of the first vial; automatically pressurizing the first vial to a predetermined pressure corresponding to the vial pressurization setting entered into the central processing unit for the first vial, said vial pressurization setting being greater than the static pressure of the first vial; automatically allowing a sample of the headspace gas to flow into a sample loop of the headspace sampling instrument; and said headspace sampling instrument pressurization setting being automatically reached as the headspace gas flows into the sample loop of the headspace sampling instrument.

Another aspect of the present disclosure allows for a method of automatically regulating and measuring pressure of a headspace sampling instrument and a plurality of vials, including, but not limited to, automatically sampling the vials with the headspace sampling instrument, the vials including at least one volatile substance in a headspace gas within each vial; preparing the plurality of vials; entering predetermined vial pressurization and headspace sampling instrument pressurization settings for each vial into a central processing unit of the headspace sampling instrument; automatically retrieving the first vial and automatically placing the first vial onto the headspace sampling instrument, said first vial having a static pressure; automatically measuring and recording the static pressure of the first vial; automatically pressurizing the first vial to a predetermined pressure corresponding to the vial pressurization setting entered into the central processing unit for the first vial, said vial pressurization setting being greater than the static pressure of the first vial; automatically allowing a sample of the headspace gas to flow into a sample loop of the headspace sampling instrument; said headspace sampling instrument pressurization setting being automatically reached as the headspace gas flows into the sample loop of the headspace sampling instrument; automatically replacing the first vial on the headspace sampling instrument with a second vial; automatically measuring and recording a static pressure within the second vial via the headspace sampling instrument; automatically pressurizing the second vial to a predetermined pressure that is greater than the static pressure of the second vial and is different from the pressure of the first vial via the headspace sampling instrument; and automatically allowing a sample of the headspace gas from the second vial to flow into a sample loop of the headspace sampling instrument.

### BRIEF DESCRIPTION OF DRAWINGS

FIG. 1 depicts an overall view of an embodiment of an automated headspace sampling instrument.

FIG. 1A depicts an embodiment of a platen heater.

FIG. 1B depicts an embodiment of a mixer assembly.

FIG. 2 is a flow diagram of an embodiment of the internal system of a headspace sampling instrument according to the present disclosure, wherein the instrument is in standby mode.

FIG. 3 is a flow diagram of the internal system of FIG. 2, wherein the pressure of the vial is being measured and recorded.

FIG. 4 is a flow diagram of the internal system of FIG. 2, wherein the vial is being pressurized.

FIG. 5 is a flow diagram of the internal system of FIG. 2, wherein volatiles are flowing from the vial to the sample loop.

FIG. 6 is a flow diagram of the sampling instrument of FIG. 2, wherein volatiles within the sample loop are injected into an analytical instrument.

### DESCRIPTION OF CERTAIN NON-LIMITING EMBODIMENTS

Automated sampling and analysis of multiple substances is beneficial as it allows for maximum efficiency of the sampling equipment and analytical instruments as well as saving time of the operators of each apparatus. Conducting sampling and analyses overnight, for example, offers tremendous gains in productivity and efficiency when multiple substances must be sampled and analyzed. Method development therefore presents a major challenge to analysts as they strive to establish limits under which many substances can be sampled and analyzed with predictable and reproducible results. In order to achieve this result when automatically sampling and analyzing volatile substances in headspace gas, one must first determine the static pressure of the vial containing the volatile substance.

Within the vial, a static vial pressure is generated as the volatile and nonvolatile portions of the substance equilibrate. Static pressure can range from, for example, approximately 0.5 to 15 psi depending on the type of substance and temperature. Prior to performing any sampling or analysis, an average static vial pressure must be measured and calculated. The average static pressure is used to determine the pressurization setting for the vial prior to performing the sampling and analysis. A vial pressurization setting is selected that is above the average static vial pressure; the setting may be, for example, approximately 2 to 4 psi above the average static vial pressure.

Pressurizing the vial to the predetermined pressure setting above average static vial pressure typically is done with helium prior to allowing the headspace gas to flow into the sampling instrument and equipment tubing. The vial must have a high enough pressure to allow it to adequately and reproducibly fill the sample loop. By adding helium or another inert gas to increase pressure within the vial, however, the amount and concentration of the volatile components within the headspace gas is diluted. Thus it is desirable to add as little pressurization gas as possible in order to maximize the amount of volatile substance within the headspace gas and optimize the overall reliability and sensitivity of the analysis.

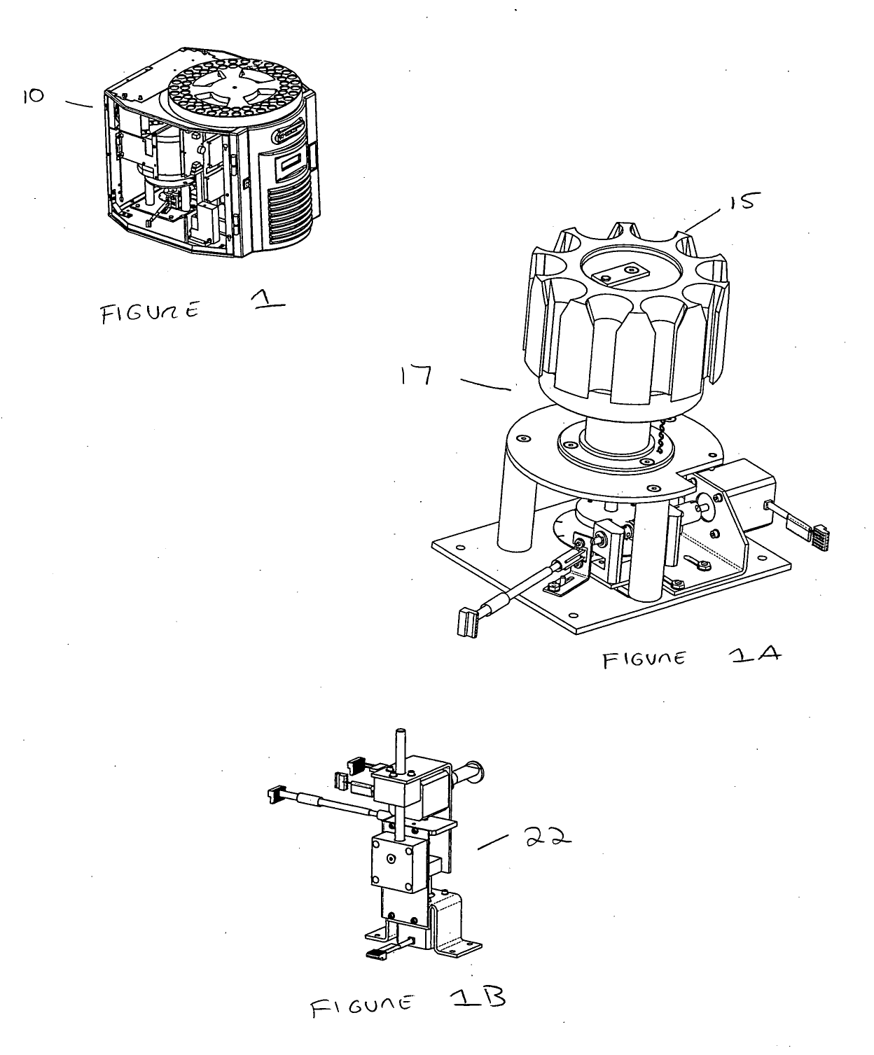

FIGS. 1-6 depict features of one non-limiting embodiment of a headspace sampling instrument 10 and internal system 20 constructed according to the present disclosure. In such an embodiment, vials containing substances to be sampled and analyzed that have been prepared by a given method may be heated for a predetermined amount of time. This allows for the substances to reach equilibrium within the vial. Each vial includes a septum and a gas tight seal to ensure that volatile components from the substance do not escape the headspace, as well as to prevent contaminants from entering the vial.

FIG. 1A generally depicts a platen heater assembly 17 where vials (not shown) may be inserted into carrousel 15 and may be heated for a predetermined time period before the vials are sampled. For example, a typical heater can raise the temperature of the vials to a temperature in the range of approximately 5° C. above room temperature to a maximum temperature of approximately 300° C. The desired temperature will depend on the nature of the substance being sampled and analyzed. In certain instances, it may be desirable to utilize equipment to lower the temperature of the vials to a temperature that is below room temperature. Typically, it is not recommended to exceed a temperature of 15° C. below the boiling point of liquid substances within the vial. Once the vials reach the desired temperature from platen heater assembly 17, they are maintained at that temperature for a predetermined period of time so as to equilibrate. In one embodiment, the equipment may be arranged to agitate the vial after it has been heated. An example of this set-up is depicted in FIG. 1B as mixer assembly 22 is used to shake the vial (not shown). Each vial may be agitated to increase the interface between the gas and liquid, thus reducing the equilibration time, but the speed of any mixing preferably is controlled so as to avoid splashing liquid substances within the vial onto the inside portion of the septa. Once the vials are heated to the predetermined temperature and/or agitated, each vial is allowed to stabilize for a predetermined amount of time.

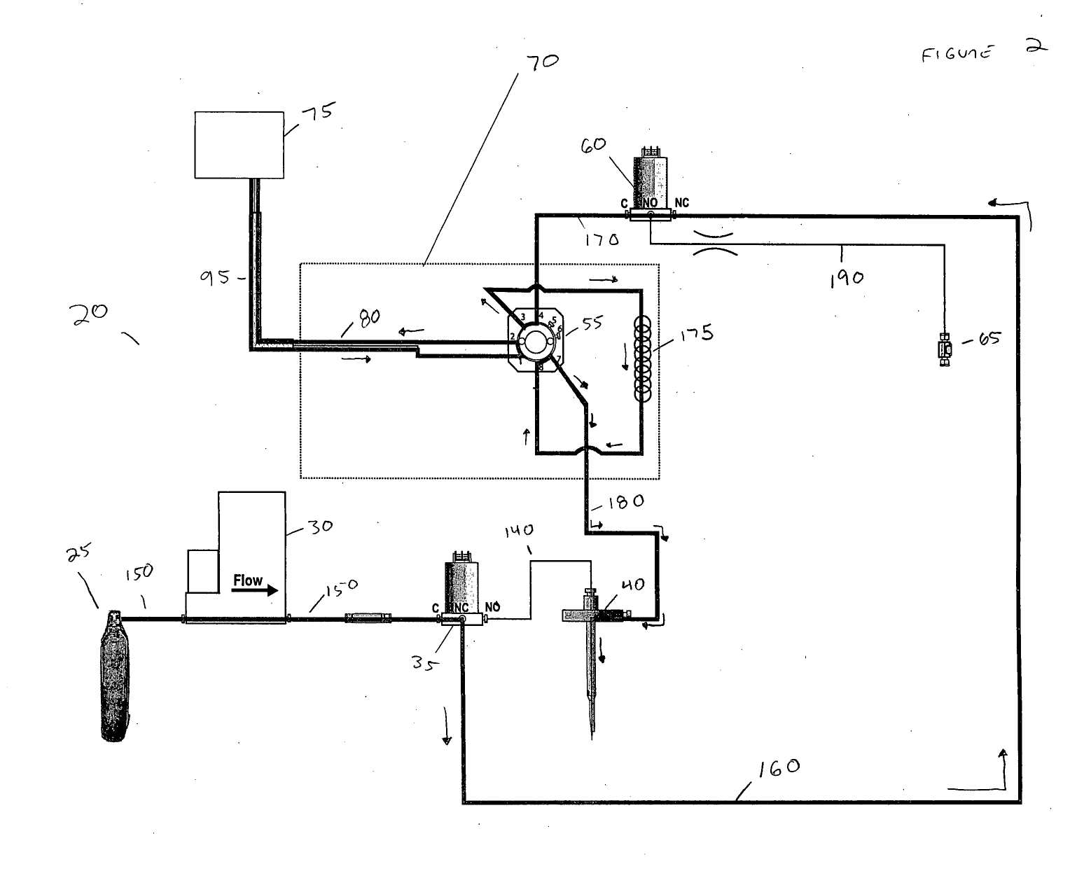

FIG. 2 schematically represents system 20 in standby mode while the vials are being heated. In standby mode, helium gas is flushed throughout the system to prevent cross contamination and carryover between each sampling and analysis event. The standby mode illustrated in the flow diagram of FIG. 2 is the state of system 20 prior to sampling a vial and analyzing the sample. A tank 25 supplies inert helium gas to a mass flow controller 30 that is in fluid communication with a pressurization valve 35. Fluid pathway 150 fluidly connects tank 25, mass flow controller 30, and pressurization valve 35.

Fluid pathway 160 connects pressurization valve 35 to venting valve 60. Venting valve 60 is also in fluid communication with a rotary multi-port valve 55 through fluid pathway 170. In addition, multi-port valve 55 is also in fluid communication with sample loop 175 at two positions. Multi-port valve 55 also is in fluid communication with sampling housing mechanism 40. Heating plate 70 maintains a consistent desired temperature of a portion of the sampling instrument as volatile substances enter analytical instrument 75. Venting valve 60 is also in fluid communication with vent 65 by way of fluid pathway 190. During standby mode, an inert gas flows through fluid pathways 150, 160, 170, 175 and 180 and through needle 45 to prevent cross-contamination and carryover between each sampling and analysis event as depicted by the solid line and arrows in FIG. 2. In standby mode, the operating pressure within the equipment tubing throughout all fluid pathways caused by the flowing gas is typically at 0.1-2 psi above atmospheric pressure. The fluid pathway tubing and connections through which the helium and headspace gas flows within system 20 may be made from, for example, nickel alloy, copper, stainless steel, or other materials that do not evolve any compounds that might affect the analysis of the volatile components within the sampled headspace gas and that are impermeable to compounds in the air that may affect the qualitative or quantitative analysis.

Multi-port valve 55 is also in fluid communication with an analytical device 75 through fluid pathways 80 and 95. During standby mode, a nominal carrier gas pressure maintains a flow between multi-port valve 55 and analytical instrument 75 through fluid pathways 80 and 95. Device 75 may be any type of apparatus that quantitatively and/or qualitatively analyzes substances including, but not limited to, gas chromatographs, mass spectrometers, and gas chromatograph-mass spectrometers.

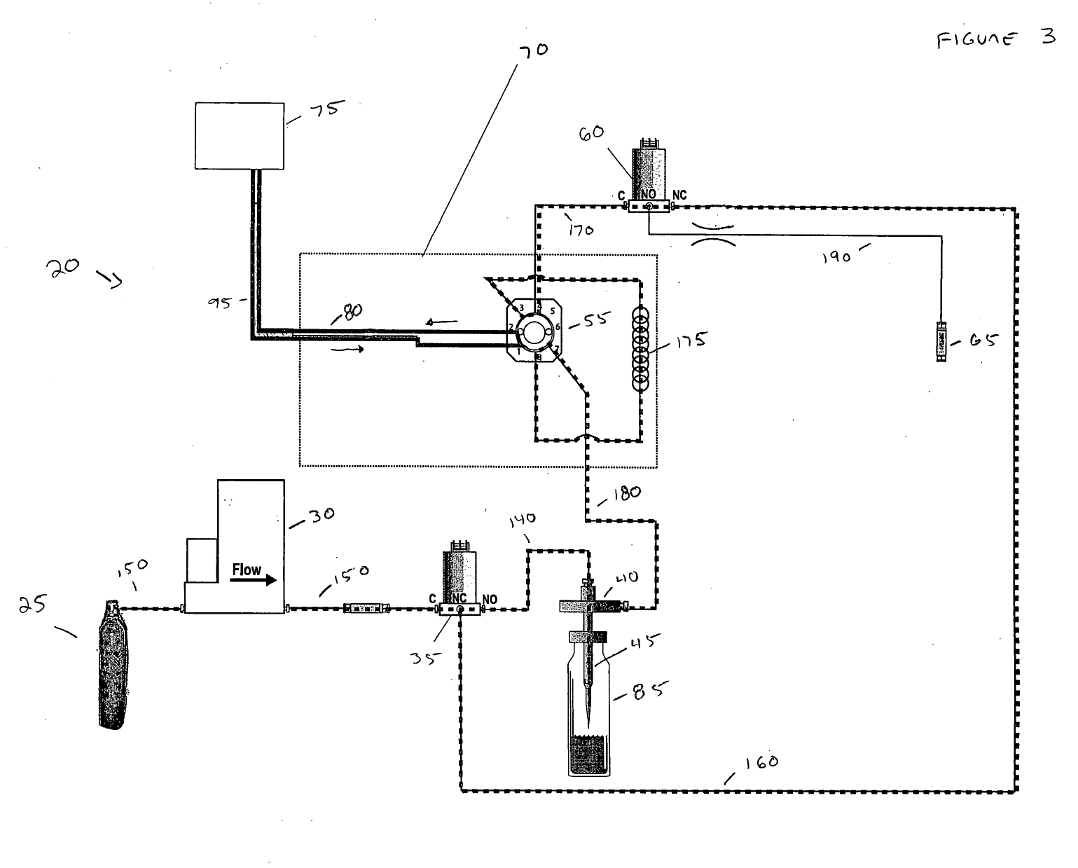

FIG. 3 is a flow diagram of system 20 representing the state of system 20 as the static pressure of vial 85 is automatically measured. Vial 85 is automatically transferred from platen heater 17 to a sampling station by means that are well known in the art. The gas-impermeable seal of vial 85 containing the substance and volatiles within the headspace gas is punctured by a single or multi-stage needle 45 as vial 85 is raised onto the sampling station. Sampling housing mechanism 40 maintains the channels for needle 45 and in this nonlimiting embodiment is also in fluid communication with pressurization valve 35 through fluid pathway 140 and multi-port valve 55 through fluid pathway 180. Vial 85 is already at a static pressure from having been previously heated to a predetermined temperature and/or agitated. To ascertain static pressure within vial 85, back pressure is exerted through one of the openings of needle 45 and the subsequent reading through pressurization valve 35 is measured by mass flow controller 30 and recorded by the central processing unit (“CPU”) of headspace sampling instrument 10. As the static pressure of the vial is measured and recorded, the flow of gas through fluid pathways 150, 160, 170, 175 and 180 is momentarily halted. The pressurized nature of these fluid pathways is depicted in FIG. 3 by a dotted line. Meanwhile, a carrier gas between analytical instrument 75 and multi-port valve 55 is maintained in fluid pathways 80 and 95 as depicted by the solid line and arrows in FIG. 3.

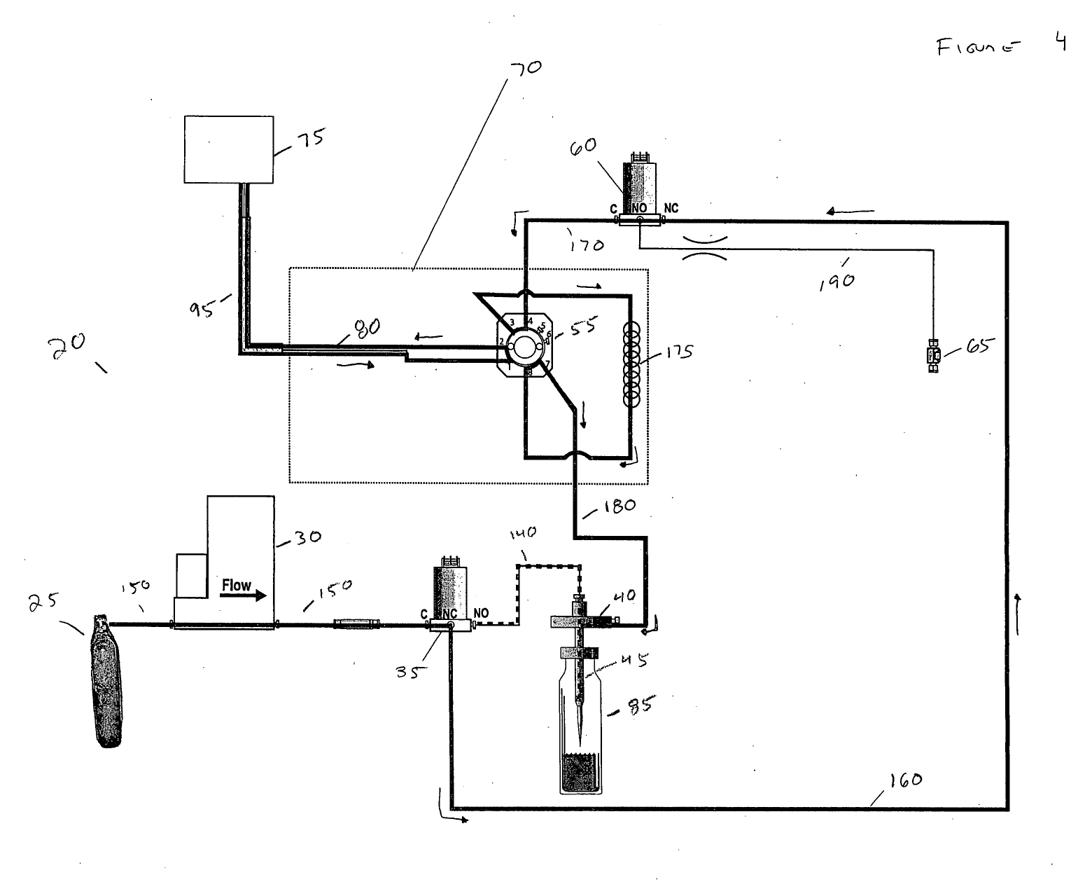

Helium gas enters vial 85 through an opening in needle 45 as depicted in FIG. 4 by the solid line and arrows through fluid pathways 150, 160, 170, 175 and 180. The flow of gas continues until either the desired predetermined pressure is reached within vial 85 or a predetermined amount of time has passed. A pressure transducer (not shown) present within mass flow controller 30 detects the back pressure on vial 85 and then closes a proportional valve (not shown) that regulates the flow of gas to vial 85 once the predetermined pressure is reached, thereby stopping the flow of gas. The flow of gas is also maintained within fluid pathways 80 and 95 by a separate supply of gas that is supplied by the analytical instrument while vial 85 is being pressurized.

The CPU of headspace sampling instrument 10 receives vial pressurization and instrument pressurization settings from the user in order to establish operating conditions for set of samples to be analyzed. The software interface of the CPU allows the user to input specific temperatures, vial pressures and instrument pressures to be reached by headspace sampling instrument 10 for each sampling event. The CPU functions with the pressure transducer to record the measurement of all pressures throughout the sampling instrument as well as the temperature of the instrument itself. As can be appreciated by those of skill in the art, this software interface allows for multiple temperature and pressure settings and each setting may be unique for either the particular vial being sampled and analyzed or may be applied to all vials in a sample run. The CPU also creates a detailed log of the activity of the instrument over time.

In some instances a vial may not be at or near its expected static pressure and also may not be able to reach the desired vial pressurization setting. If this occurs, the CPU will detect the variance and then allow the vial to receive helium gas for a predetermined amount of time. After gas has been supplied to the vial for the given amount of time, the actual vial pressure is recorded and the volatile substance within the vial is sampled and analyzed as set forth more fully below.

Whenever a pressure and/or temperature setting is changed or otherwise adjusted, at least a short amount of time must be allowed for equilibrium to be attained as the sampling instrument and/or vial reaches the new pressure and/or temperature. If a different pressure setting has been set by the user, then the amount of gas flowing within the fluid pathways at this stage may be varied from vial to vial. Typically, pressure settings can range from atmospheric pressure to approximately 30 psi. System 20 preferably attains equilibrium in this stage to ensure reproducibility.

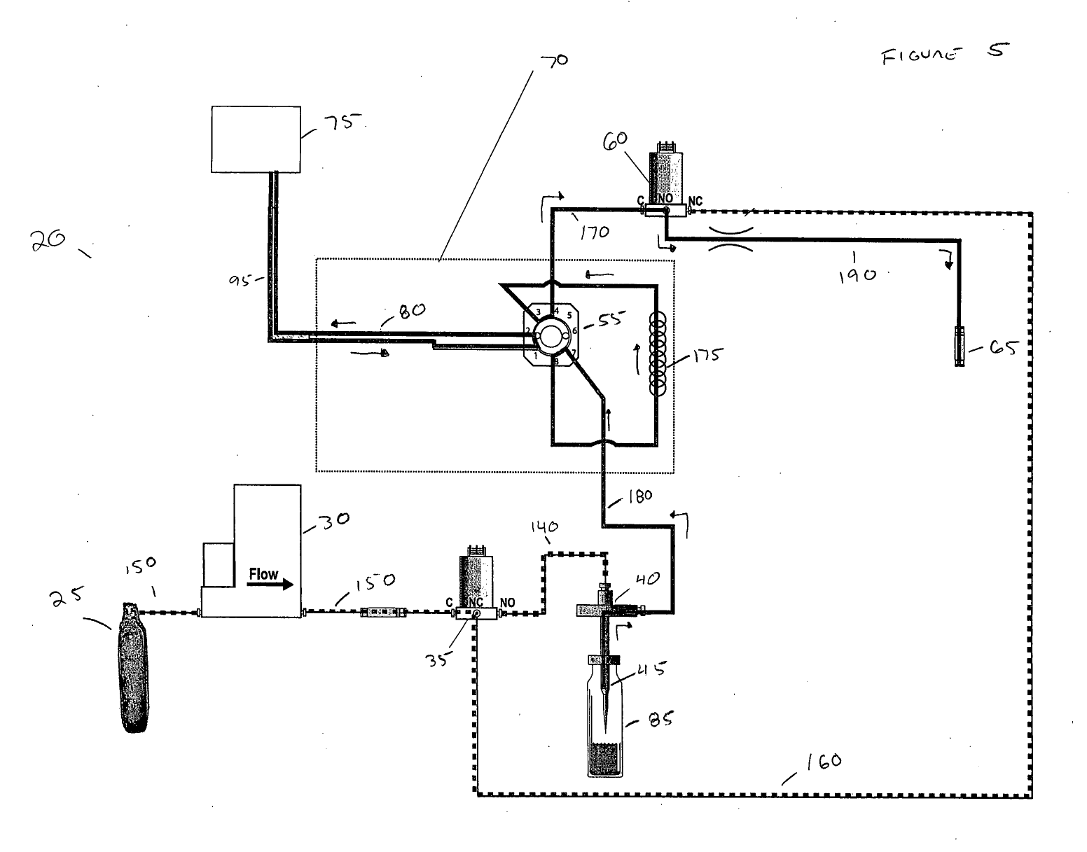

In the flow diagram of FIG. 5, venting valve 60 has been opened after the predetermined period of equilibrium. This creates a drop in pressure and causes the existing gas within fluid pathways 180, 175 and 170 to flow through venting valve 60 through fluid pathway 190 and out vent 65. An instrument pressurization setting that is typically 1-2 psi lower than the vial pressurization setting controls the amount of pressure decay that occurs as the headspace gas containing the volatile substances flows from vial 85 through fluid pathway 180 to multi-port valve 55 and then into sample loop 175. Venting valve 60 is closed once the desired instrument pressurization setting is reached in order to capture the headspace gas within sample loop 175. Again, the dotted line depicts fluid pathways that remain at a fixed pressure as the fluid pathways illustrated with solid lines and arrows depict pathways that have an active gas flow. It will be appreciated by those of skill in the art that multi-port valve 55, as a rotary multi-port valve such as, for example, an 8-port valve like model no. EPX2LC8WT manufactured by Valco Instruments Co., Inc., allows for the simultaneous venting of fluid pathway 170 while the headspace gas enters fluid pathways 180 and then sample loop 175. Oven plate 70 maintains a constant temperature in the area of the sampling instrument containing sample loop 175 to ensure that the volatile components reach the same temperature prior to analysis.

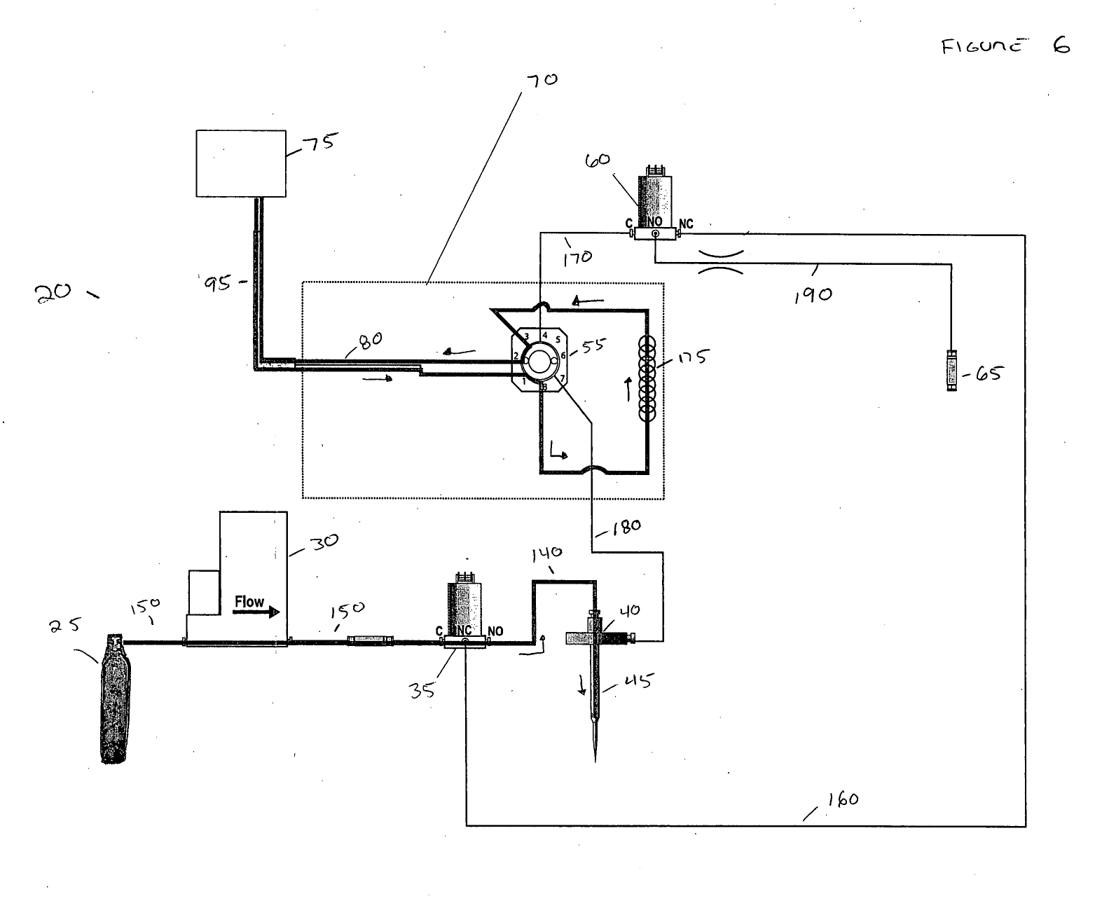

FIG. 6 is a flow diagram of system 20 representing the state of system 20 as volatiles are injected from sample loop 175 into analytical instrument 75, depicted in this embodiment as a gas chromatograph. To facilitate the analysis, multi-port valve 55 rotates so that sample loop 175 fluidly communicates with fluid paths 80 and 95. In this way, the gas flow coming from analytical instrument 75 in fluid pathway 95 communicates with sample loop 175 thereby pushing volatile substances from sample loop 175 through fluid pathway 80 and onto the column (not shown) of gas chromatograph 75 for qualitative and/or quantitative analysis. Simultaneously with this action, vial 85 is removed from the headspace sampling instrument and gas flow resumes through fluid pathways 150 and 140 in order to flush needle 45 as depicted by solid lines and arrows. In alternative nonlimiting embodiments, the volatile substance from sample loop 175 may be transferred to a mass spectrometer, gas chromatograph-mass spectrometer, or other type of analytical instrument that is capable of quantitative and/or qualitative analysis. After the analysis occurs, a leak check can occur to ensure that the system is functioning properly.

Following are examples illustrating certain aspects of non-limiting embodiments of a method according to the present disclosure. It will be understood that the following examples are merely intended to illustrate certain nonlimiting embodiments and are not intended to limit the scope of the present disclosure in any way. It will also be understood that the full scope of the inventions encompassed by the present disclosure is better indicated by the claims appended to the present description.

Sampling methods according to the present disclosure are highly flexible. For example, an operator may choose to run a single automated sampling and analysis event involving both a set of vials containing aqueous substances and a set of vials containing substances with numerous alcohols. As part of method development, the set of aqueous samples may be heated at 85° C. for 20 minutes, and an internal static pressure of each vial of about 5-6 psi would be measured and recorded. At least three vials should be used to determine an average static vial pressure. To determine the pressure of the vial during sampling of the headspace gas, a vial pressurization setting must be determined that is greater than the average static vial pressure for the samples. At the same time, the vial pressurization setting must not be too much greater than the average static vial pressure so as to prevent over-dilution of the headspace. In this nonlimiting example, the preferred vial pressurization setting for the aqueous samples may be 7-8 psi, or approximately 2 psi higher than the average static vial pressure.

Continuing development of this method example, the samples containing alcohols might achieve an internal static pressure of 10 psi after heating at 85° C. for 4 minutes. Again, at least three vials should be used to get an average static vial pressure. A preferred vial pressurization setting for the alcohol based samples may be 12 psi, or approximately 2 psi higher than the average static vial pressure. In conventional automated sampling techniques, as only one vial pressurization setting was possible during an automated sampling and analysis event, both the aqueous and alcohol based samples would necessarily have been pressurized to the higher vial pressurization setting, in this case 12 psi, which would result in a large dilution of the headspace gas of the aqueous samples. In embodiments of systems and methods according to the present disclosure, the user can input a vial pressurization setting of 7-8 psi for the set of aqueous samples and a vial pressurization setting of 12 psi for the set of samples containing alcohol into the CPU interface on the headspace sampling instrument.

In rare cases, vials within a sample set do not have the same static pressure and, thus, differing amounts of pressurizing gas must be added to each vial to achieve the same vial pressurization at the gauge. Differing final vial pressures result in different dilution factors applied to each sample, which may make the data less useful. In such a case, a volumetric pressurization may be selected instead of a vial pressurization setting. This may be accomplished according to the present disclosure by selecting a maximum pressure setting (e.g., 30 psi) and a relatively short pressurization time (e.g. 0.5 to 1.0 minute). In this situation, each vial will have a consistent volume of inert gas added to it. If the pre-selected maximum pressure setting is obtained prior to reaching the pre-selected pressurization time, the mass flow controller will stop the flow of gas at the pre-selected maximum pressure and proceed with the sampling and analysis of the substance.

Prior to an automated sampling and analysis, a pressure setting for the equipment tubing, which includes the sample loop, is selected that is typically 2-3 psi below the vial pressurization setting for a 1 ml pathway. This ensures that the headspace gas containing the volatile substance will naturally and reproducibly fill the fluid pathway because it is at a lower pressure. If smaller fluid pathways are utilized, the difference in pressure between the vial and the fluid pathway may be less than 2-3 psi, and if larger fluid pathways are utilized the difference in pressure may be greater than 2-3 psi to better ensure that the fluid pathway is reproducibly filled. In the above examples, the instrument pressure setting on a 1 ml pathway would be in the approximate range of 4-6 psi for the aqueous samples and in the approximate range of 9-10 psi for the substances containing alcohols. The present disclosure allows for both instrument pressure settings to be automatically reached by the headspace sampling instrument during automated sampling and analyses.

Another example is when samples in both liquid and solid form must be automatically sampled and analyzed at the same time and at the same temperature. If an aqueous sample with a high concentration of certain volatile substances was allowed to equilibrate at 85° C., the static pressure of a vial might be approximately 5-7 psi. A sample with a solid substance, for instance polymer beads, might only reach a static pressure of 1-2 psi after being allowed to equilibrate at 85° C. as well. In order to automatically sample and analyze the volatiles in the headspace for both vials, a vial pressurization setting in the approximate range of 7-9 psi would be entered into the CPU for the aqueous sample and a vial pressurization setting in the approximate range of 3-4 psi would be entered for the solid sample. Corresponding instrument pressurization settings would also be entered in the approximate range of 4-7 psi for the aqueous sample and in the approximate range of 1-2 psi for the solid sample, respectively, depending on the average static pressure as determined during method development.

Although the foregoing description has necessarily presented a limited number of embodiments, those of ordinary skill in the relevant art will appreciate that various changes in the components, compositions, details, materials, and process parameters of the examples that have been herein described and illustrated in order to explain the nature of the invention may be made by those skilled in the art, and all such modifications will remain within the principle and scope of the invention as expressed herein and in the appended claims. It will also be appreciated by those skilled in the art that changes could be made to the embodiments described above without departing from the broad inventive concept thereof. It is understood, therefore, that this invention is not limited to the particular embodiments disclosed, but it is intended to cover modifications that are within the principle and scope of the invention, as defined by the claims.

What is claimed is:

1. A method of automatically regulating and measuring pressure of a vial by a headspace sampling instrument, said vial being automatically sampled by the headspace sampling instrument and including at least one volatile substance in a headspace gas within the vial, the method comprising: automatically placing the vial on the headspace sampling instrument; automatically measuring and recording a static pressure within the vial via the headspace sampling instrument; automatically pressurizing the vial to a predetermined pressure that is greater than the static pressure via the headspace sampling instrument; and automatically allowing a sample of the headspace gas to flow into a sample loop of the headspace sampling instrument.

2. The method of claim 1 further comprising automatically allowing the headspace gas within the vial to reach equilibrium prior to automatically placing the vial on the headspace sampling instrument.

3. The method of claim 2 wherein the vial is automatically heated for a predetermined time period in order for the headspace gas within the vial to reach equilibrium.

4. The method of claim 2 wherein the vial is automatically heated for a predetermined time period and the vial is then mixed in order for the headspace gas within the vial to reach equilibrium.

5. The method of claim 1 further comprising establishing and entering a headspace sampling instrument pressurization setting prior to automatically placing the vial on the headspace sampling instrument, said headspace sampling instrument pressurization setting being automatically reached as the headspace gas flows into the sample loop of the headspace sampling instrument.

6. The method of claim 1 further comprising automatically piercing the vial with a needle as the vial is automatically placed on the headspace sampling instrument.

7. The method of claim 6 wherein the needle is a multi stage needle.

8. The method of claim 6 wherein the needle is a single stage needle.

9. The method of claim 1 further comprising automatically quantitatively or qualitatively analyzing a volatile substance in the sample of headspace gas with an analytical instrument.

10. The method of claim 9 whereby the analytical instrument is selected from the group consisting of gas chromatographs, mass spectrometers, and gas chromatograph-mass spectrometers.

11. A method of automatically regulating and measuring pressure of a plurality of vials by a headspace sampling instrument, said vials being automatically sampled by the headspace sampling instrument and including at least one volatile substance in a headspace gas within each vial, the method comprising: automatically placing a first vial on the headspace sampling instrument; automatically measuring and recording a static pressure within the first vial via the headspace sampling instrument; automatically pressurizing the first vial to a predetermined pressure that is greater than the static pressure via the headspace sampling instrument; automatically allowing a sample of the headspace gas from the first vial to flow into a sample loop of the headspace sampling instrument; automatically replacing the first vial on the headspace sampling instrument with a second vial; automatically measuring and recording a static pressure within the second vial via the headspace sampling instrument; automatically pressurizing the second vial to a predetermined pressure that is greater than the static pressure of the second vial and is different from the pressure of the first vial via the headspace sampling instrument; and automatically allowing a sample of the headspace gas from the second vial to flow into a sample loop of the headspace sampling instrument.

12. The method of claim 11 further comprising automatically allowing the headspace gas within each vial to reach equilibrium prior to automatically placing each vial on the headspace sampling instrument.

13. The method of claim 12 wherein each vial is automatically individually heated for a predetermined time period in order for the headspace gas within each vial to reach equilibrium.

14. The method of claim 12 wherein each vial is automatically individually heated for a predetermined time period and each vial is then individually mixed in order for the headspace gas within each vial to reach equilibrium.

15. The method of claim 11 further comprising establishing and entering a headspace sampling instrument pressurization setting prior to automatically placing the vial on the headspace sampling instrument, said headspace sampling instrument pressurization setting being automatically reached as the headspace gas flows into the sample loop of the headspace sampling instrument.

16. The method of claim 11 further comprising automatically piercing each vial with a needle as each vial is automatically placed on the headspace sampling instrument.

17. The method of claim 16 wherein the needle is a multi stage needle.

18. The method of claim 16 wherein the needle is a single stage needle.

19. The method of claim 11 further comprising automatically quantitatively or qualitatively analyzing a volatile substance in the sample of headspace gas with an analytical instrument.

20. The method of claim 19 whereby the analytical instrument is selected from the group consisting of gas chromatographs, mass spectrometers, and gas chromatograph-mass spectrometers.

21. A method of automatically regulating and measuring pressure of a headspace sampling instrument and a plurality of vials, said vials being automatically sampled with the headspace sampling instrument and including at least one volatile substance in a headspace gas within each vial, the method comprising: preparing the plurality of vials; entering predetermined vial pressurization and headspace sampling instrument pressurization settings for each vial into a central processing unit of the headspace sampling instrument; automatically retrieving the first vial and automatically placing the first vial onto the headspace sampling instrument, said first vial having a static pressure; automatically measuring and recording the static pressure of the first vial; automatically pressurizing the first vial to a predetermined pressure corresponding to the vial pressurization setting entered into the central processing unit for the first vial, said vial pressurization setting being greater than the static pressure of the first vial; automatically allowing a sample of the headspace gas to flow into a sample loop of the headspace sampling instrument; and said headspace sampling instrument pressurization setting being automatically reached as the headspace gas flows into the sample loop of the headspace sampling instrument.

22. The method of claim 21 further comprising: automatically replacing the first vial on the headspace sampling instrument with a second vial.

23. The method of claim 21 further comprising automatically allowing the headspace gas within each vial to reach equilibrium prior to automatically being placed on the headspace sampling instrument.

24. The method of claim 23 wherein each vial is automatically individually heated for a predetermined time period in order for the headspace gas within each vial to reach equilibrium.

25. The method of claim 23 wherein each vial is automatically individually heated for a predetermined time period and each vial is then individually mixed in order for the headspace gas within each vial to reach equilibrium.

26. The method of claim 21 further comprising automatically piercing the first vial with a needle as the first vial is automatically placed on the headspace sampling instrument.

27. The method of claim 26 wherein the needle is a multi stage needle.

28. The method of claim 26 wherein the needle is a single stage needle.

29. The method of claim 21 further comprising automatically quantitatively or qualitatively analyzing a volatile substance in the headspace gas with an analytical instrument.

30. The method of claim 29 whereby the analytical instrument is selected from the group consisting of gas chromatographs, mass spectrometers, and gas chromatograph-mass spectrometers.

31. The method of claim 22 further comprising: automatically measuring and recording a static pressure within the second vial via the headspace sampling instrument; automatically pressurizing the second vial to a predetermined pressure that is greater than the static pressure of the second vial and is different from the pressure of the first vial via the headspace sampling instrument; and automatically allowing a sample of the headspace gas from the second vial to flow into a sample loop of the headspace sampling instrument.

32. The method of claim 31 further comprising: a second headspace sampling instrument pressurization setting corresponding to the headspace sampling instrument pressurization setting entered into the central processing unit for the second vial being automatically reached as the headspace gas of the second vial flows into the sample loop of the headspace sampling instrument.

33. The method of claim 32 wherein the first headspace sampling instrument pressurization setting is different from the second headspace sampling instrument pressurization setting.

34. The method of claim 31 wherein the vial pressurization setting entered into the central processing unit for the first vial is different from the vial pressurization setting entered into the central processing unit for the second vial.

35. The method of claim 32 wherein the first headspace sampling instrument pressurization setting is different from the second headspace sampling instrument pressurization setting and the vial pressurization setting entered into the central processing unit for the first vial is different from the vial pressurization setting entered into the central processing unit for the second vial. sampling instrument; automatically pressurizing the second vial to a predetermined pressure that is greater than the static pressure of the second vial and is different from the pressure of the first vial via the headspace sampling instrument; and automatically allowing a sample of the headspace gas from the second vial to flow into a sample loop of the headspace sampling instrument.

32. The method of claim 31 further comprising: a second headspace sampling instrument pressurization setting corresponding to the headspace sampling instrument pressurization setting entered into the central processing unit for the second vial being automatically reached as the headspace gas of the second vial flows into the sample loop of the headspace sampling instrument.

33. The method of claim 32 wherein the first headspace sampling instrument pressurization setting is different from the second headspace sampling instrument pressurization setting.

34. The method of claim 31 wherein the vial pressurization setting entered into the central processing unit for the first vial is different from the vial pressurization setting entered into the central processing unit for the second vial.

35. The method of claim 32 wherein the first headspace sampling instrument pressurization setting is different from the second headspace sampling instrument pressurization setting and the vial pressurization setting entered into the central processing unit for the first vial is different from the vial pressurization setting entered into the central processing unit for the second vial.
